(19) United States
(12) Patent Application Publication
(10) Pub. No.: US 2005/0236048 A1
(43) Pub. Date: Oct. 27, 2005

(54) Fluid inlet device

(76) Inventors: Bart Griepsma, Tiel (NL); Emil Fehr, Irchel (CH)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 11/113,536

(22) Filed: Apr. 25, 2005

(30) Foreign Application Priority Data
Apr. 23, 2004 (EP) 04405249.6

(51) Int. Cl. G05D 7/00

(52) U.S. Cl. 137/592

(57) ABSTRACT

The fluid inlet device for an apparatus, in particular for a column, has an inflow stub for the supply of a fluid which can be single phase or multi-phase. A distribution chamber adjoins the inflow stub and has guide lamellae arranged at at least one open side of the chamber by means of which a fluid can be distributed into the column on curved paths. Each guide lamella is mounted to the wall panels of the distribution chamber via plug connections. The stability of the construction is established by fixing one or all plug connections to the respective wall panel by welding, nut and bolt assemblies, snap fitting and/or wedges.

This invention relates to a fluid inlet device. More particularly, this invention relates to a fluid inlet device for a column. Still more particularly, this invention relates to a column having a fluid inlet device for distributing fluid into the column.

As is known, for example, from DE-A-1 519 711, a fluid inlet device, namely an inlet and distribution device, has been used for delivering a fluid, such as a liquid/vapor mixture, into a column where the liquid carried along in the fluid can be separated. When such a fluid inlet device is used, the inflowing fluid is branched off into partial flows by a plurality of curved guide lamellae or guide vanes and each partial flow is deflected such that the denser liquid phase of the mixture can be at least partly separated under centrifugal force. The vapor is distributed over the column cross-section, whereas the liquid is separated. However, the speed of the inflowing fluid is so high, as a rule, that the forces that act on the inlet device require the inlet device to have a stable construction.

The known fluid inlet device can naturally also be used for the feeding in of a single phase fluid (liquid or gas).

A stable construction which particularly maintains its shape is advantageously made from sheet metal panels. In this case, the guide lamellae are welded at their side edges to the wall panels of the distribution chamber of the fluid inlet device along contact lines between the lamellae and the plates. However, strains arise in the construction due to the welding operation that must be relieved by means of a heat treatment. Without the heat treatment, the fluid inlet device would greatly deform when a hot fluid, for example, vaporised crude oil which can have a temperature of 500° C., is fed through the device resulting in the fluid being insufficiently distributed in a column.

Further disadvantages moreover exist since relatively complex work processes are required for the welding. The dimensions which are possible for the fluid inlet device are also limited, because accessibility must be ensured in order to apply weld seams between the guide lamellae and the wall plates.

Accordingly, it is an object of the invention to provide a fluid inlet device that forms a construction of stable shape at increased temperature.

It is another object of the invention to provide a fluid inlet device that can be manufactured with a low work effort and, in particular, without a heat treatment.

Briefly, the invention is directed to a fluid inlet device that has an inflow stub for the supply of a fluid and a distribution chamber adjoining the inflow stub for receiving the fluid wherein the chamber includes a base panel, a top panel and a plurality of spaced apart guide lamellae disposed between the base panel and the top panel at at least one open side of the chamber for distributing fluid therefrom on curved tracks or paths.

In accordance with the invention, a plurality of plug connections are used for mounting the guide lamella to the base panel and the top panel and a plurality of connection means are used for fixing at least some of said plug connections to a respective one of the two panels.

The fluid inlet device is provided for an apparatus, in particular for a column, and the inflow stub is positioned at the wall of the column for the supply of a fluid that can be single phase or multi-phase. The distribution chamber feeds the fluid into the apparatus, guided on curved paths, over a surface of the apparatus. In the case of a two-phase fluid, a dispersed phase of higher density can be at least partly separated under centrifugal force at the same time as the distribution takes place.

These and other objects and advantages of the invention will become more apparent from the following detailed description taken in conjunction with the accompanying drawings wherein:

FIG. 1 illustrates a part cross-sectional plan view of a known fluid inlet device that extends across a column cross-section;

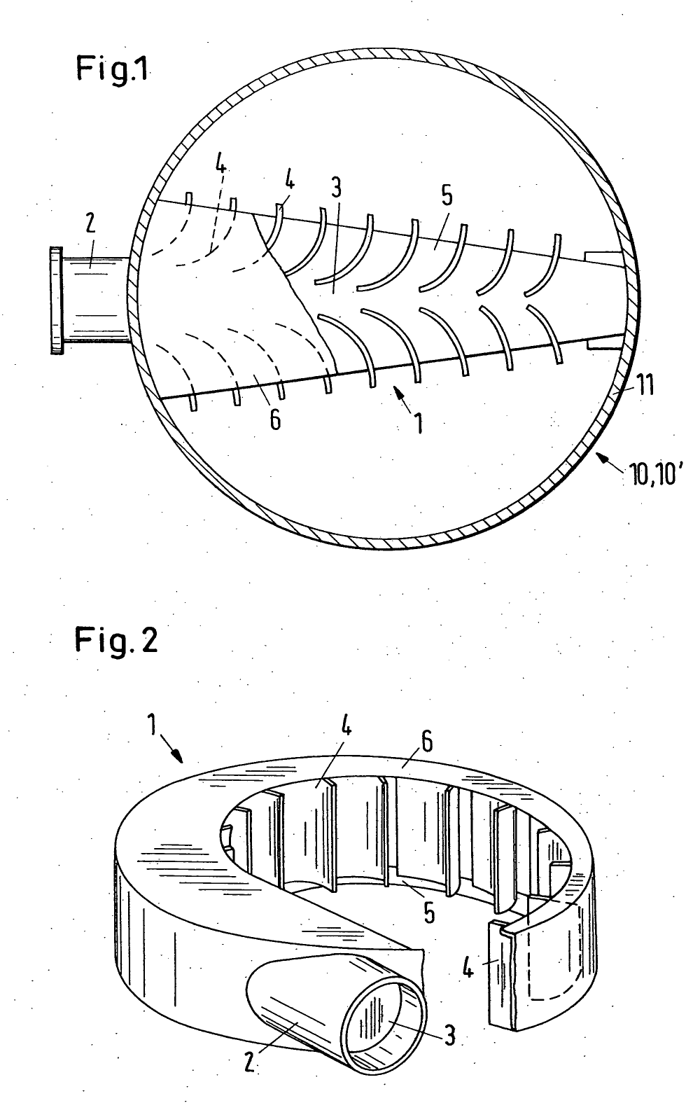

FIG. 2 illustrates a part cross-sectional plan view of a known fluid inlet device that extends peripherally about a column cross-section;

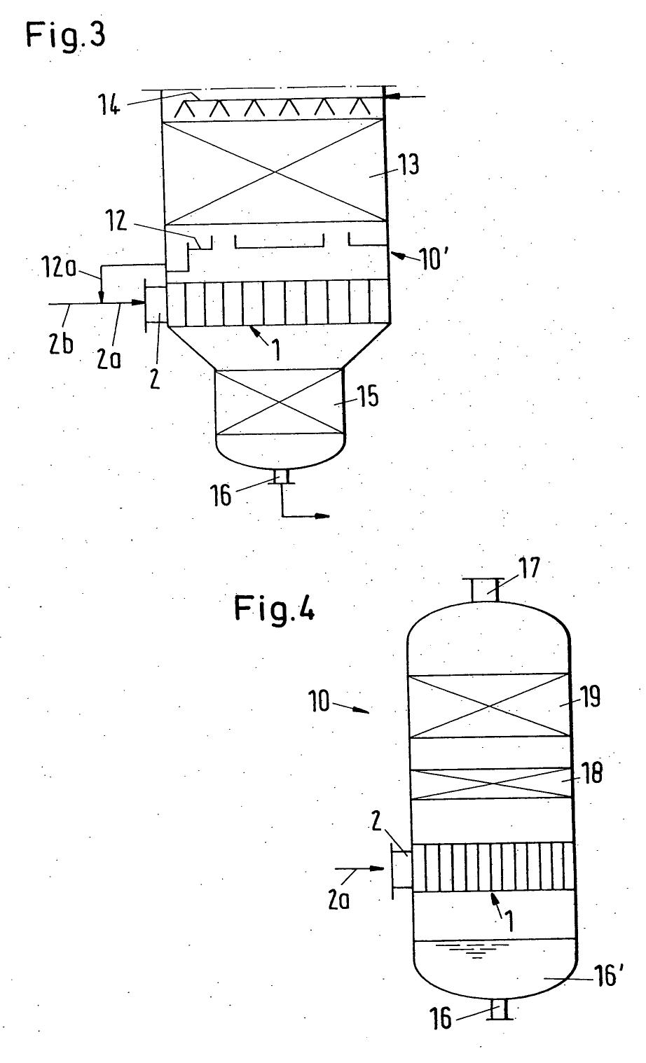

FIG. 3 illustrates a schematic view of a lower part of a column in which a fluid inlet device in accordance with the invention can be used;

FIG. 4 illustrates a schematic view of a column for the separation of two phases from a liquid/vapor mixture;

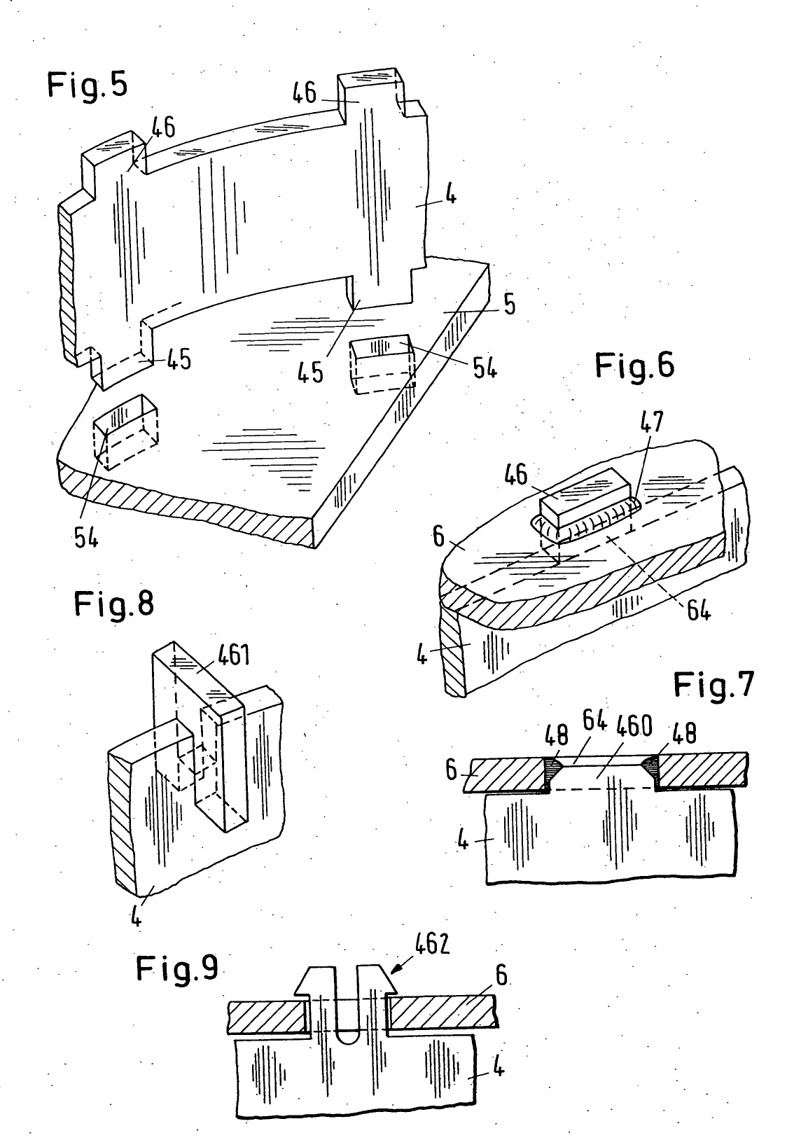

FIG. 5 illustrates a part perspective view of a plug connection between a lamella and a wall panel of a fluid inlet device in accordance with the invention;

FIG. 6 illustrates a perspective view of a weld connection means for fixing a plug connection in accordance with the invention.

FIG. 7 illustrates a perspective view of a spot weld connection means for fixing a plug connection in accordance with the invention;

FIG. 8 illustrates a perspective view of a construction variant of a plug connection on the upper edge of a guide lamella in accordance with the invention;

FIG. 9 illustrates a perspective view of a releasable plug connection with snap-in locking in accordance with the invention;

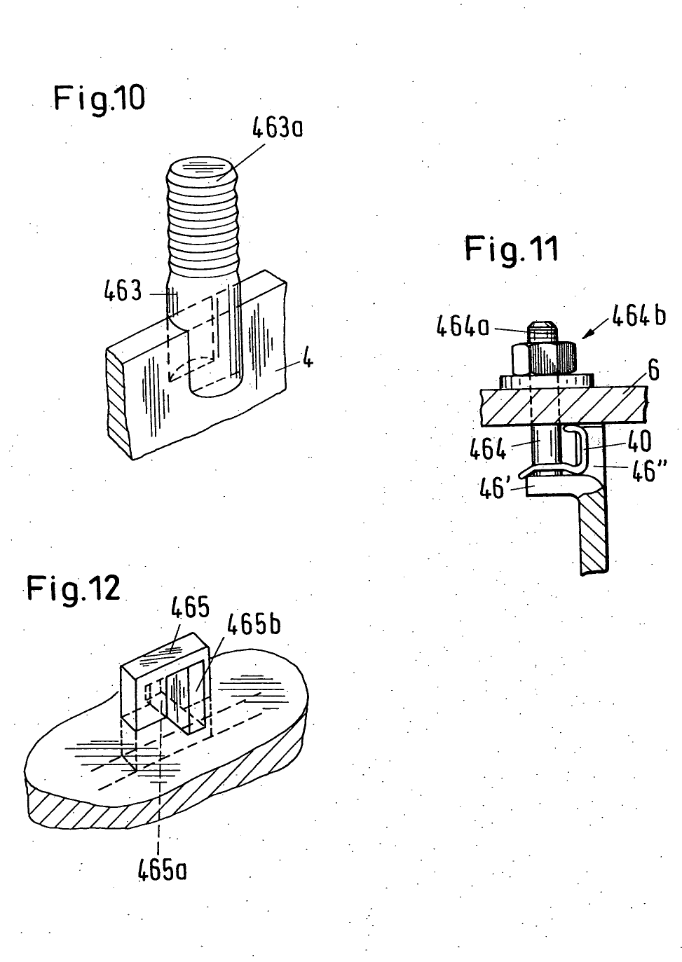

FIG. 10 illustrates a perspective view of plug connection employing a bolt with a screw thread mounted to the upper edge of a guide lamella in accordance with the invention;

FIG. 11 illustrates a plug connection between a guide lamella and the top panel or the base panel with a screw connection in accordance with the invention; and

FIG. 12 illustrates a wedge-secured plug connection in accordance with the invention.

The fluid inlet devices 1 shown in FIGS. 1 and 2 are provided for apparatuses 10, in particular for columns 10′, such as are shown as examples in FIGS. 3 and 4.

Referring to FIG. 1, the fluid inlet device 1 includes an inflow stub 2 at a wall 11 of the apparatus 10 and a distribution chamber 3 adjoining downstream that extends diametrically across the column cross-section. The distribution chamber 2 has curved guide lamellae 4 arranged at two open sides so that a fluid to be fed into the apparatus 10 can be distributed, guided on curved tracks, over a surface of the apparatus 10, in particular over a cross-sectional surface of the column 10′. A phase of higher density dispersed in the fluid can be at least partly separated simultaneously under centrifugal forces.

Wall panels, namely a base panel 5 and a top panel 6, form closed sides of the distribution chamber 3. These wall panels 5 and 6 result—together with the guide lamellae 4 secured to them as described below—in a construction of stable shape.

In accordance with the invention, each guide lamella 4 is connected to the wall panels 5 and 6 at side edges via plug connections that provide a form fitted connection. Such plug connections will be described in the following with reference to FIGS. 5 to 12. The stability of the construction is established by fixing one or more of the plug connections by means of additional connection means.

In FIG. 1, the distribution chamber 3 is in the shape of an isosceles triangle in plan view with two open sides. The guide lamellae 4 line the two limbs of this triangle.

In FIG. 2, wherein like reference characters indicate like parts as above, the distribution chamber 3 has only one open side and forms a passage which extends at the inner side of a cylindrical apparatus wall (not shown) in the form of a part ring. The guide lamellae 4 line the discharge region at the center side between the passage base panel 5 and the passage top panel 6. The cross-sectional surface of the passage becomes smaller in the flow direction in correspondence with a reducing flow rate.

In FIG. 3, a lower part of a column 10′ is shown whose fluid inlet device 1 is advantageously made in accordance with the invention. A liquid/vapor mixture 2a which is made up of a returned liquid 12a and partly vaporised crude oil 2b is fed in through the stub 2. The returned liquid 12a is a loaded washing liquid which is applied to a pack 13 using a distributor 14 and which is collected in a collector 12 after running through the pack and after being loaded with substances from a vapor flow. Liquid is at least partly separated from the vapor in the fluid inlet device 1. The liquid enters into a pack 15 arranged beneath the fluid inlet device 1; volatile components are absorbed there from the liquid by a stripping agent, in particular by steam, and are conveyed into the upper part of the column 10′. The liquid discharged from the pack 15 is removed via the outlet 16 in a sump.

FIG. 4 shows an apparatus 10 for the separation of the two phases of a liquid/vapor mixture 2a. This apparatus 10 is known from EP-A-0 195 464. Fine liquid droplets move with a vapor flow from the fluid inlet device 1 into a device 18 in which coalescence into larger drops takes place. These drops are transported with the vapor flow into a further device 19 and are separated there using centrifugal forces. The liquid separated in this manner is collected in the sump 16′ together with a first liquid fraction from the fluid inlet device 1 and removed via the outlet 16. The vapor flow liberated from the liquid is removed via a stub 17 at the head of the apparatus 10.

The plug connections of the guide lamellae 4, which connect via shape matching, can be realised in different manners and several examples are described below.

FIG. 5 shows a first example in which sections of a guide lamella 4 and of the base panel 5 of a fluid inlet device 1 have separate plug connections.

Referring to FIG. 5, a lamella 4 is provided at the bottom edge with projections 45 in the form of tabs or tongues, each of which forms one element of the plug connection. The base panel 5 is provided with slit-like openings 54, each of which forms the other element of the plug connection. The openings 54 are arranged in correspondence to the tongues 45 and are sized to have the tongues 45 inserted therein. The dimensions of the openings 54 are constructed to match the tongues 45 so that a connection is formed by shape matching.

Tongues 46 are provided in the same manner at the upper edge of the guide lamella 4 and plug connections to the top panel 6 can be established by means of them: cf. FIGS. 6 and 7 (plug connections with openings 64).

Individual plug connections or all plug connections are fixed in accordance with the invention using additional connection means. In this respect, there is a minimum number of fixing points for which the stability of the construction is ensured. A specific distribution pattern—or also more than one—is associated with this minimum number and the positions of the fixing points must be arranged in accordance with it. For increased security or for improved stability, a larger number of fixing points than is required for the distribution pattern can also be provided.

The fixing of the plug connections can be established by mechanical bonding, in particular by welding. FIG. 6 shows a welding of the plug connection. With this fixing, the projecting flanks of the tongue 46 are secured to the wall panel, e.g. the top panel 6, with a contiguous welding seam 47. Instead of such a full mechanical bonding, a partial mechanical bonding is also possible in which, for example, a welding seam is only attached to one flank of the tongue 46.

A further example for a partial mechanical bonding is shown in FIG. 7 wherein the tongue 460 does not protrude beyond the opening 64. Only two spot welds 48 are made at the two ends of the tongue 460. However, there is also the possibility of filling the recess which has remained open in the opening 64 between the two spot welds 48 with welded material.

In contrast to the known fluid inlet device, weld positions only occur at limited locations within the device 1. Thus, no strains result which impair the shape stability.

Referring to FIG. 8, a plug connection includes a recess in an edge of a lamella 4 and a platelet 461 form fitted or pushed into the recess in perpendicular relation. As illustrated, the platelet 461 has a pair of legs astride the lamella 4. The platelet 461 may be fixed by shape matching or by welding. Since this element 461 stands transversely to the flow direction of the fluid flowing along the guide lamella 4 during use of the fluid inlet device 1, a small disturbance results which, however, does not have any substantial influence on the distribution quality and separation quality of the fluid inlet device 1.

Referring to FIG. 9, the plug connection includes an opening in the top panel (or base panel) and a tab 462 on a lamella 4 with a pair of hook-shaped limbs snap-fitted into and through opening. The two hook-shaped limbs can be resiliently deflected toward one another. This plug connection represents a releasable fixing.

The fixing of a plug connection can be established at at least individual fixing points in each case by means of a releasable connection means, for example by a screw connection or a wedge. FIG. 10 shows, for this purpose, a bolt 463 which is mounted on the upper edge of the guide lamella 4 and which has a screw thread 463a at the head end. This plug connection element is inserted into a bore of the top panel 6 (not shown) and is secured to the panel 6 by means of a nut. Individual bolts 463 without screw heads can also be inserted into corresponding bores as non-fixed plug connections.

A variant screw connection is shown in FIG. 11 wherein a bore is provided in the top panel 6 (or base panel) and a bent over tab 46′ is formed from the top edge of the lamella to define an opening 46″. An L-shaped sheet metal element 40 is mounted on the tab 46′ to block the opening 46″ and a bolt 464 is mounted on the tab 46′ to project through the sheet metal element 40 to hold the element 40 in place and through the bore in the panel 6. The bolt 464 has a threaded end 464a to receive a nut and washer assembly 464b to secure the bolt 464 to the panel 6.

Referring to FIG. 12, the plug connection may include an opening in a respective one of the base panel and the top panel and a tab 465 on the edge of a lamella that projects through the opening wherein the tab 465 has an aperture 465a exposed on the outside of the panel. The connection means is in the form of a wedge 465b that extends through the aperture 465a and engages the panel on the side opposite the lamella.

The invention thus provides a fluid inlet device 1 that can be used to feed a fluid that can be multi-phase or single phase into an apparatus (for example a column) in order to distribute the fluid across the cross-section of the apparatus. For example, referring to FIG. 3, a gas flow 2a supplied to the apparatus can be loaded with a denser phase, for example with liquid droplets, which are separated during feeding. Also, the fluid can consist of only one material or of a single phase material mixture.

1. A fluid inlet device comprising
an inflow stub for the supply of a fluid;
a distribution chamber adjoining said stub for receiving the fluid, said chamber including a base panel, a top panel and a plurality of spaced apart guide lamellae disposed between said base panel and said top panel at at least one open side of said chamber for distributing fluid therefrom on curved tracks;
a plurality of plug connections for mounting said guide lamella to said base panel and said top panel; and
a plurality of connection means for fixing at least some of said plug connections to a respective one of said base panel and said top panel.

2. A fluid inlet device as set forth in claim 1 wherein at least one of said connection means is a spot weld.

3. A fluid inlet device as set forth in claim 1 wherein at least one of said plug connections includes an opening in a respective one of said base panel and said top panel and a tab on a respective lamella form fitted into said opening and wherein at least one of said connection means is a weld seam extending between said tab and said respective panel.

4. A fluid inlet device as set forth in claim 1 wherein at least one of said plug connections includes a recess in an edge of one of said lamellae and a platelet form fitted into said recess in perpendicular relation, said platelet having a pair of legs astride said one lamella.

5. A fluid inlet device as set forth in claim 1 wherein at least one of said plug connections includes an opening in a respective one of said base panel and said top panel and a tab on a respective lamella with a pair of hook-shaped limbs snap fitted into and through said opening.

6. A fluid inlet device as set forth in claim 1 wherein at least one of said plug connections includes a bore in a respective one of said base panel and said top panel and a threaded bolt on a respective lamella projecting through said bore.

7. A fluid inlet device as set forth in claim 6 wherein at least one of said connection means is a nut threaded onto said threaded bolt.

8. A fluid inlet device as set forth in claim 1 wherein at least one of said plug connections includes a bore in a respective one of said base panel and said top panel, a bent over tab in an edge of one of said lamellae defining an opening therein, an L-shaped sheet metal element on said tab blocking said opening and a bolt mounted on said tab and projecting through said sheet metal element and said bore.

9. A fluid inlet device as set forth in claim 8 wherein at least one of said connection means is a nut threaded onto said threaded bolt.

10. A fluid inlet device as set forth in claim 1 wherein at least one of said plug connections includes an opening in a respective one of said base panel and said top panel and a tab having an aperture on a respective lamella for passing through said opening and wherein at least one of said connection means is a wedge extending through said opening and engaging said respective one of said base panel and said top panel on a side opposite said respective lamella.

11. A fluid inlet device as set forth in claim 1 wherein said distribution chamber has the shape of an isosceles triangle and said lamellae are disposed on two sides thereof.

12. A fluid inlet device as set forth in claim 1 wherein said distribution chamber in the form of a part ring and has a decreasing cross-section in a direction extending away from said inflow stub.

13. In combination,
a column; and
a fluid inlet device mounted in said column for distributing fluid into said column, said device comprising an inflow stub for the supply of a fluid; a distribution chamber adjoining said stub for receiving the fluid, said chamber including a base panel, a top panel and a plurality of spaced apart guide lamellae disposed between said base panel and said top panel at at least one open side of said chamber for distributing fluid therefrom on curved tracks into said column; a plurality of plug connections for mounting said guide lamella to said base panel and said top panel; and a plurality of connection means for fixing at least some of said plug connections to a respective one of said base panel and said top panel.

14. The combination as set forth in claim 13 further comprising at least one liquid collector disposed below said fluid inlet device.
